(19) United States
(12) Patent Application Publication
(10) Pub. No.: US 2009/0148552 A1
(43) Pub. Date: Jun. 11, 2009

(54) Mold apparatus

(75) Inventors: Hisashi Sawada, Okazaki-city (JP); Shuichi Tamaki, Nishio-city (JP); Yukinori Narita, Toyokawa-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/316,024

(22) Filed: Dec. 9, 2008

(30) Foreign Application Priority Data
Dec. 11, 2007 (JP) 2007-320027

(51) Int. Cl. B29C 45/16

(52) U.S. Cl. 425/575

(57) ABSTRACT

A mold apparatus for two-color molding provided with a movable partitioning member able to be used even when a first cavity for molding a first thermoplastic resin and a second cavity for molding a second thermoplastic resin are completely different in shape or their connecting part is not simple in shape, that is, a mold apparatus for integral molding of two types of thermoplastic resins to produce a two-color shaped article having a movable partitioning member partitioning a space for molding two types of thermoplastic resin into a first space for molding a first thermoplastic resin and a second space for molding a second thermoplastic resin, wherein the movable partitioning member is provided with a hole forming part of the second space 11b.

### BACKGROUND OF THE PRESENT INVENTION

1. Field of the Invention

The present invention relates to a mold apparatus which integrally molds two types of thermoplastic resins to produce a two-color shaped article, more particularly relates to a mold apparatus for a shaped article comprised of a main part and a packing part which molds the main part by a second thermoplastic resin and molds the packing part by a first thermoplastic resin.

2. Description of the Related Art

When it is necessary due to the demands for physical properties or design to mold one article from a plurality of types of resins or a plurality of the same type of resin having different colors, the two-color molding method has been employed in the past. This two-color molding method first injects a first molten resin into a first cavity to mold a first resin part, then injects a second molten resin into the second cavity adjacent to the first cavity to mold a second resin part. By doing so, the first resin part and the second resin part are melt bonded together whereby an integrated two-color shaped article is molded.

With this two-color molding method, it is necessary to partition the first cavity and the second cavity so as to limit the flow of the first molten resin to the second cavity. As this method, when using a plurality of different molds, there is the method of partitioning the molds themselves, but when using one type of mold, as described in Japanese Patent Publication (A) No. 11-48284, partitioning by a slide core (movable partitioning member) is often used.

The slide core described in Japanese Patent Publication (A) No. 11-48284 can be used when the first cavity and the second cavity are simple, similar shapes and the connecting part between them is also a simple shape. However, when first cavity is for the packing part and the second cavity is for the main part, the first cavity and the second cavity will be completely different shapes or the connecting part between them will not be simple in shape. That is, when the two-color shaped article is comprised of a main part and packing part, the slide core of Japanese Patent Publication (A) No. 11-48284 cannot be used.

### SUMMARY OF THE PRESENT INVENTION

The present invention was made in consideration of the above problem and has as its object to provide a mold apparatus for two-color molding provided with a movable partitioning member able to be used even when a first cavity for molding a first thermoplastic resin and a second cavity for molding a second thermoplastic resin are completely different in shape or a connecting part between them is not simple in shape.

The present invention provides a mold apparatus of the following aspects as the means for solving the above problems. According to a first aspect of the present invention, the mold apparatus (100) is characterized in that the movable partitioning member (3) is provided with a hole (3a) forming part of a second space (11b).

In the hole (3a), a connecting part (51a) with a packing part (52) in the main part (51) can be formed. The hole (3a) may be formed to any shape, so the connecting part (51a) to which the hole shape is transferred may also be formed to any shape. Due to this, the movable partitioning member (3) can be used even when the first cavity (11a) and the second cavity (11b) have completely different shapes and when their connecting part (51a) has a non-simple shape.

According to a second aspect of the present invention, the mold apparatus (200, 300) is characterized in that the movable partitioning member (22, 32) is provided with a first space (22a, 32a.) Due to this, it becomes possible to produce various shapes of first resin molded parts.

According to a third aspect of the present invention, the mold apparatus (100, 200, 300) is characterized in that the first thermoplastic resin is a soft resin, the second thermoplastic resin is a hard resin, the two-color shaped article (50, 60, 70) is comprised of the main part (51, 61, 71a) and packing part (52, 62, 71b), the main part (51, 61, 71a) is made from the second thermoplastic resin, and the packing part (52, 62, 71b) is made from the first thermoplastic resin.

Conventionally, the main body was molded from a resin and assembled with a separately fabricated packing to form the finished product. By integrally molding the main body and the packing, the quality control costs, assembly costs, and maintenance and management costs can be reduced.

According to a fourth embodiment of the present invention, the mold apparatus is a mold apparatus for integrally molding a large number of types of thermoplastic resins to produce a multi-colored shaped article characterized by including a mold apparatus of any one of the first to third aspects (100, 200, 300). This shows that the two-color molding use mold of the present invention can also be applied to multi-colored molding. Note the numerals in parentheses after the means described in the claims and this section show the correspondence with specific means described in the later-mentioned embodiments.

### BRIEF DESCRIPTION OF THE DRAWINGS

These and other objects and features of the present invention will become clearer from the following description of the preferred embodiments given with reference to the attached drawings, wherein:

FIG. 1 is a view showing a process time chart of a molding method using the mold apparatus of the present invention;

FIG. 2 is a view showing the state of the mold apparatus in a shaped article takeout step and a closed first space forming step using the mold apparatus of the first embodiment of the present invention;

FIG. 3 is a view showing the state of the mold apparatus in a shaped article takeout step and a first resin injection step using the mold apparatus of the first embodiment of the present invention;

FIG. 4 is a view showing the state of the mold apparatus in a mold closing step and a first and second space communication step using the mold apparatus of the first embodiment of the present invention;

FIG. 5 is a view showing the state of the mold apparatus in a second resin injection step using the mold apparatus of the first embodiment of the present invention;

FIG. 6 is a view showing a two-color shaped article shaped in the first embodiment of the present invention;

FIG. 7 gives views for explaining movement of a cavity partitioning member of the first embodiment of the present invention;

FIG. 8 is a view showing a two-color shaped article molded by a second embodiment of the present invention;

FIG. 9 is a view showing movement of a first space member of the second embodiment of the present invention;

FIG. 10 is a view showing a state of use of a two-color shaped article molded by a third embodiment of the present invention;

FIG. 11 is a view showing a two-color shaped article molded by a third embodiment of the present invention;

FIG. 12 is a view showing movement of a first space member of the third embodiment of the present invention; and

FIG. 13 is a view showing movement of a first space member of the third embodiment of the present invention;

wherein 1 indicates a fixed side mold, 2 a movable side mold, 3 a movable cavity partitioning member, 4 an injection nozzle, 5 a compact injection molding unit, 6 a shaft, 11 a cavity, 22 a first space member of the second embodiment, 32 a first space member of the third embodiment, 50 a two-color shaped article of the first embodiment, and 100 a mold apparatus of the first embodiment.

### DESCRIPTION OF THE PREFERRED EMBODIMENTS

Below, an embodiment of the present invention will be described based on the drawings. In the specification, the “movable partitioning member” means the member partitioning the space for molding two types of thermoplastic resins to a first space for molding a first thermoplastic resin and a second space for molding a second thermoplastic resin, while the “movable first space member” means the movable partitioning member provided itself with the first space into which the first thermoplastic resin is filled by injection. Further, in the specification, the “displacement” of the member means displacement of at least one position of the member surface in translational motion, rotational motion, and all other motion of the member.

### First Embodiment

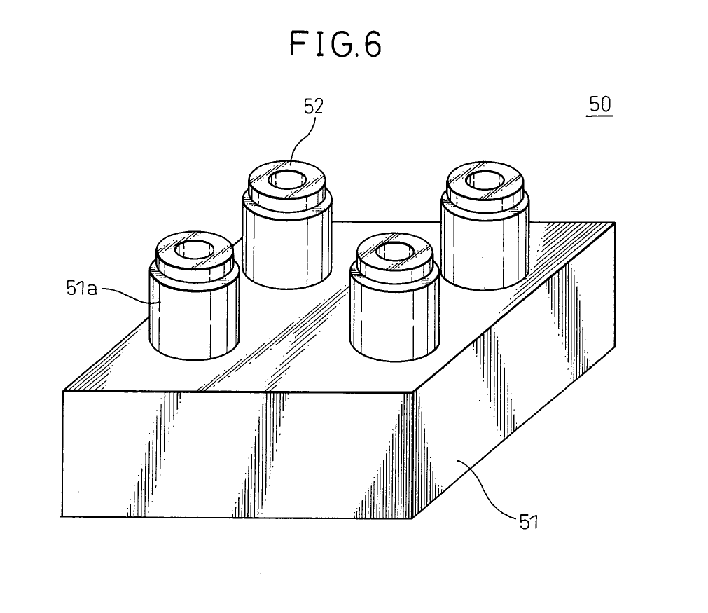

First, a first embodiment of the present invention will be explained. The first embodiment is a mold apparatus 100 using a movable cavity partitioning member partitioning a cavity formed by a fixed side mold and movable side mold into a first space and second space (hereinafter, simply referred to as a “cavity partitioning member”). FIG. 6 is a schematic view showing a two-color shaped article 50 molded by the first embodiment. The two-color shaped article 50 is comprised of a main part 51 and packing part 52. The main part 51 has a rectangular shape having four boss parts 51a. At each cylindrical boss part 51a, a donut-shaped packing part or seal part (hereinafter simply referred to as a “packing part”) 52 is melt bonded to be formed integral with it. The main part 51 (including the boss parts 51a) is made by a hard resin (second resin), for example, a general-use resin polypropylene, and the packing part 52 is made by a soft resin (first resin), for example, an elastomer.

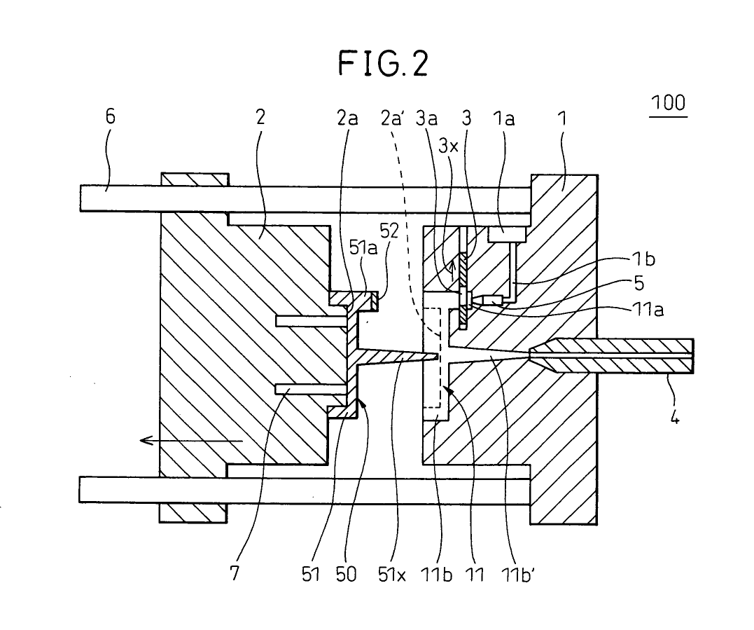

Further, FIG. 6 shows a two-color shaped article from which a sprue 51x (see FIG. 2) molded by a resin passage is cut off. The two-color shaped article 50 may be, for example, a vehicular air-conditioner part or any other case, cover, or other product. Of course, the main part does not have to include the boss parts and may have a shape that is not rectangular but cylindrical or the shape of a spiral casing or the like. Further, the packing part is not limited to a donut shape and may be rectangular or any other shape.

Next, a mold apparatus 100 of the first embodiment will be described based on FIG. 2. FIG. 2 is a view showing the state of a mold apparatus 100 in a shaped article takeout step and a closed first space forming step of the first embodiment. The mold apparatus 100 has a fixed side mold 1, a movable side mold 2 freely openable and closable with respect to the fixed side mold 1, and a cavity partitioning member 3 arranged at the fixed side mold 1 and partitioning a cavity 11 formed by the fixed side mold 1 and the movable side mold 2 into a first space 11a and second space 11b. The cavity partitioning member 3 may be arranged at the movable side mold 2 as well. The fixed side mold 1 and movable side mold 2 are supported by a shaft 6 provided at a polypropylene injection molding machine that injection molds polypropylene (second resin). The fixed side mold 1 is fixed to the shaft 6, while the movable side mold 2 guides the shaft 6 to move in a straight line in a slidable fashion to open or close the mold.

The fixed side mold 1 has an injection nozzle 4 of the second resin injection molding machine inserted into it at its center part. Polypropylene (second resin) is injected from the injection nozzle 4. Further, the fixed side mold 1 is provided with a compact injection molding unit (first resin injection molding unit) 5, a hopper 1a holding an elastomer material, and a transport path 1b transporting the elastomer material from the hopper la to the compact injection molding unit 5. The compact injection molding unit 5 is an apparatus for injecting the elastomer (first resin) and has the functions of plasticizing, weighing, and feeding the elastomer. In FIG. 2, the compact injection molding unit 5 is built in the mold, but of course it may also be provided outside it.

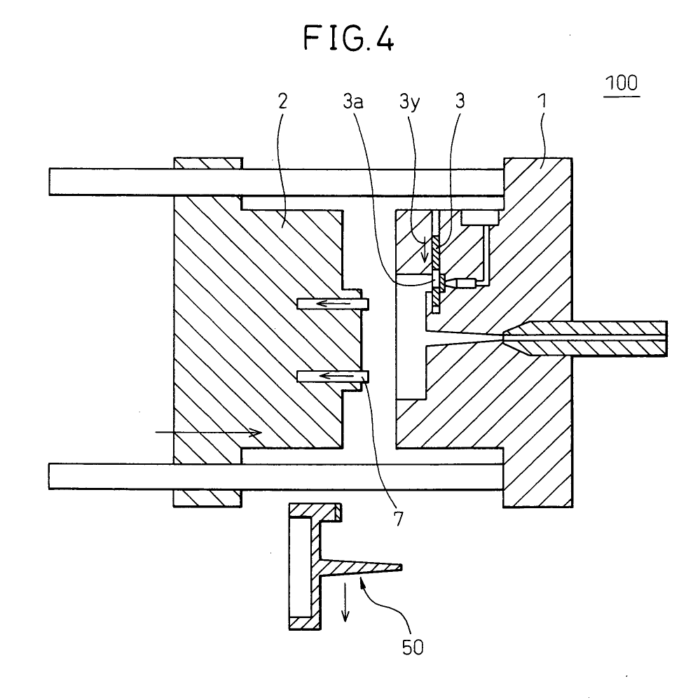

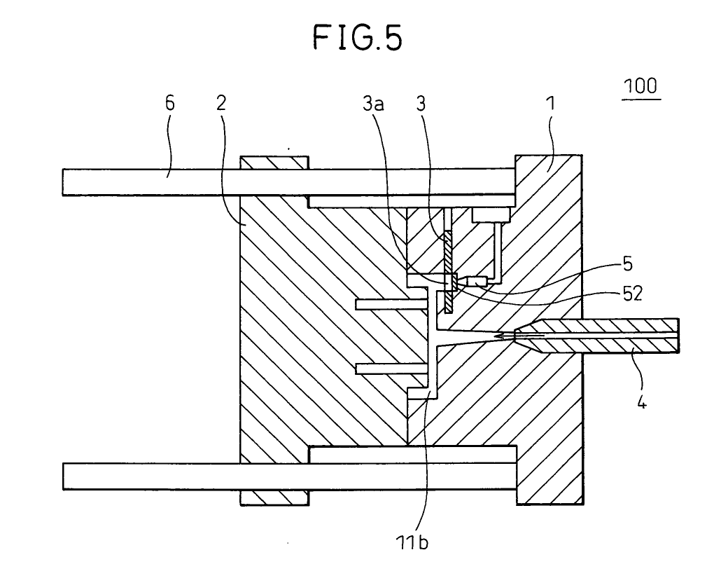

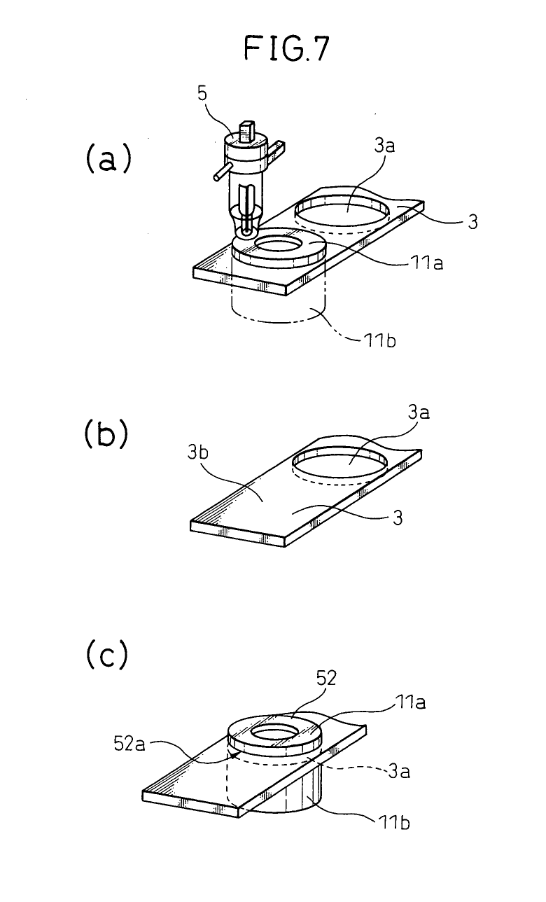

Between the fixed side mold 1 and the movable side mold 2 is formed a space for molding the resin, that is, a cavity 11. Note that the dotted line 2a′ of FIG. 2 shows the surface 2a of the movable side mold 2 when the movable side mold 2 is clamped (the mold is closed) (see FIG. 5). The fixed side mold 1 is provided with the cavity partitioning member 3 (see FIG. 7) in a manner enabling it to freely advance and retract. The cavity partitioning member 3 retracts (arrow 3x of FIG. 2) to partition the cavity 11 into the first space 11a and the second space 11b. Further, it advances (arrow 3y of FIG. 4) to communicate and open the first space 11a and second space 11b partitioned by this through the hole 3a of the cavity partitioning member 3 to return to the original cavity 11 state. The first space 11a is a space filled by injection of the elastomer, while the second space 11b is a space filled by injection of polypropylene. The second space 11b includes a sprue 11b′ of the molten resin passage. Note that the boundary between the first space 11a and second space 11b is shown by the dotted line 2a′ in FIG. 2.

The movement of the cavity partitioning member 3 will be explained with reference to FIG. 7. FIG. 7 gives views showing the internal structure of the mold. FIG. 7(a) shows the relationship among the cavity partitioning member 3, the compact injection molding unit 5, and the mold cavity 11 when the cavity partitioning member 3 is in a retracted state. FIG. 7(b) shows only the cavity partitioning member 3. The cavity partitioning member 3 is provided with a hole 3a of the same diameter as the boss parts 51a of the shaped article 50. Due to the retracted state of the cavity partitioning member 3 shown in FIG. 7(a), the cavity 11 is partitioned into the first space 11a and second space 11b via the flat part (no hole) 3b of the cavity partitioning member 3. FIG. 7(c) is a view showing the relationship among the cavity partitioning member 3, the hole 3a of the cavity partitioning member 3, and the mold cavity 11 when the cavity partitioning member 3 is in the advanced state. The position of the compact injection molding unit 5 is the same as the position in FIG. 7(a). Due to the advanced state of the cavity partitioning member 3, the partitioned first space 11a and second space 11b are communicated and opened through the hole 3a and returned to the original cavity 11. In the hole 3a, a connecting part 51a with a packing part 52 in the main part 51 can be formed. The hole 3a may be formed to any shape, so the connecting part 51a to which the hole shape is transferred may also be formed to any shape. Due to this, the movable partitioning member 3 can be used even when the first cavity 11a and the second cavity 11b have completely different shapes and when their connecting part 51a has a non-simple shape.

The movable side mold 2 has the shaped article 50 stuck to it immediately after being molded. In FIG. 2, for simplification, of the normally four packing parts 52 and boss parts 51a, only one each is shown. The rest are omitted. Further, in the shaped article 50, a sprue 51x molded in the resin passage 11b′ is formed. This sprue 51x is not necessary in the final product, so is cut off and disposed of after being taken out from the mold. The movable side mold 2 is provided with a plurality of ejector pins 7 for detaching the shaped article 50 from the movable side mold 2.

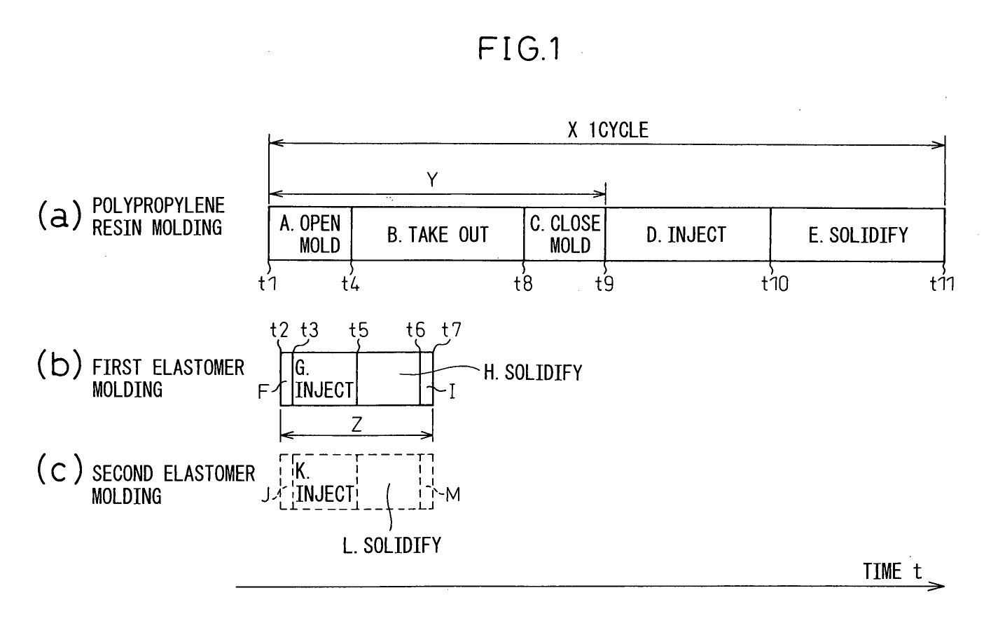

Next, based on FIG. 1, the process for molding a two-color shaped article using the mold apparatus of the first embodiment will be described. FIG. 1 is a view showing time charts of the molding process. (a) is a time chart showing a molding step of a polypropylene resin, (b) showing a molding step of the first elastomer, and (c) showing a molding step of the second elastomer in units of time on the horizontal axis. (a), (b), and (c) are each shown by the same time axis.

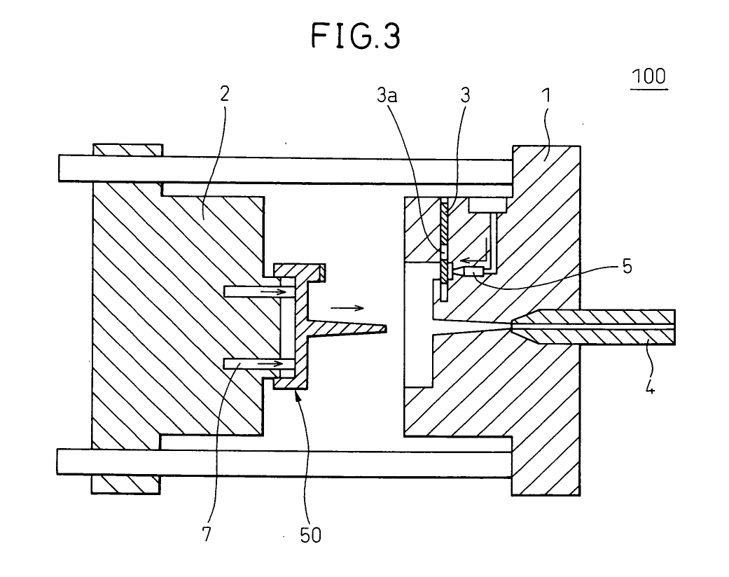

First, the steps of (a) and (b) will be explained. At the time t1, the movable side mold 2 begins to open from the state where it is clamped to the fixed side mold 1 (see FIG. 5). Due to the hydraulic pressure drive apparatus (not shown) of the injection molding machine, the movable side mold 2 is guided by the shaft 6 and moved to the left direction (see FIG. 2). The state where the movement of the movable side mold 2 is halted is shown in FIG. 2. At the time t2 where some time has passed since the movable side mold 2 began opening, the cavity partitioning member 3 begins moving upward (arrow 3x direction in FIG. 2). At the time t3, the cavity partitioning member 3 finishes its movement upward whereby the cavity 11 is partitioned into the first space 11a and the second space 11b, and the second space 11b is completely shut off from the first space 11a (see FIG. 3). The period from the time t2 to the time t3 becomes the closed first space forming steps F and J.

At the time t3, the cavity partitioning member 3 finishes its upward movement, whereby the compact injection molding unit 5 begins injection of the molten first elastomer. At the time t5, the first elastomer finishes being injected. The period from the time t3 to the time t5 becomes the first resin injection steps G and K. At the time t5, the molten first elastomer is cooled by the mold 1, and at time t6, solidification of the first elastomer is finished. The period from the time t5 to the time t6 becomes the first resin solidification steps H and L. At the time t6, the cavity partitioning member 3 begins to move downward (the arrow 3y direction in FIG. 4). At the time t7, the cavity partitioning member 3 finishes moving downward, whereby the partitioned first space 11a and second space 11b form the cavity 11 by communicating through the hole 3a of the cavity partitioning member 3 (see FIG. 5). The period from the time t6 to the time t7 becomes the first and second space communication steps I and M.

On the other hand, at the time t4 where some time has passed since the time t3 where the cavity partitioning member 3 finishes moving upward, the leftward movement of the movable side mold 2 is finished and the movable side mold 2 is completely open in state (see FIG. 3). When the movable side mold 2 is in an open state, the ejector pins 7 begin protruding toward the two-color shaped article 50 formed in the previous shaping cycle and stuck to the movable side mold 2. At the time t8, the protruding lengths of the ejector pins 7 become the maximum and the two-color shaped article 50 detaches from the movable side mold 2. The period from the time t1 to the time t8 becomes the shaped article takeout steps A and B. Further, the protrusion from the ejector pins 7 may begin before the movable side mold 2 finishes opening. At the time t8 where the two-color shaped article 50 is detached, the movable side mold 2 begins moving rightward and begins to close the mold. In parallel with this, the ejector pins 7 begin retracting towards their original positions.

At the time t9, the movable side mold 2 is closed and clamped to the fixed side mold 1 (see FIG. 5). The period from the time t8 to the time t9 becomes the mold closing step C.

At the time t9, when the mold is closed, the molten polypropylene resin is injected from the injection nozzle 4 of the injection molding machine (not shown). The first elastomer filled in the first space 11a melt bonds with the molten polypropylene at the end face 52a (see FIG. 7(c)). At the time t10, the polypropylene finishes being injected. The period from the time t9 to the time t10 becomes the second resin injection step D. In the period from the time t10 to the time t11, the molten polypropylene resin is cooled and solidified by the mold. The period from the time t10 to the time t11 becomes the second resin solidification step E. By doing this, the two-color shaped article 50 integrally molded from the first resin (first elastomer) and the second resin (polypropylene) is molded. At the time t11, when the polypropylene finishes being solidified, one cycle of molding is completed. The next molding cycle begins again at the time t1. By doing this, the steps from the time t1 to the time t11 are repeated, whereby the shaped article 50 is manufactured in large quantities.

In the molding process, the shaped article takeout steps (A and B), mold closing step C, closed first space forming step F, first resin injection step G, first resin solidification step H, and first and second space communication step I proceed in parallel; the closed first space forming step F begins after the time ti where the shaped article takeout step is started; and the mold closing step C is finished after the time t7 where the first and second space communication step is finished.

That is, by performing the elastomer molding process using the time Z from the time t2 to the time t7 in the range of the time period Y needed for the shaped article takeout step and mold closing step from the time t1 to the time t9, the time of the shaped article takeout step and mold closing step which was not actively used at all in the past can be used effectively for the molding process. By this, the molding time X of 1 cycle can be reduced.

In the above description, the molding of only one first resin (elastomer) coupled with the molding of the second resin (polypropylene) was described. That is, only the (b) molding of the first elastomer was described in FIG. 1. However, as shown in FIG. 1(c), multi-color molding performing molding of the second elastomer in parallel with molding of the first elastomer is of course possible. Further, multi-color molding performing molding of a plurality of elastomers such as molding of a third elastomer, molding of a fourth elastomer, . . . is of course possible.

### Second Embodiment

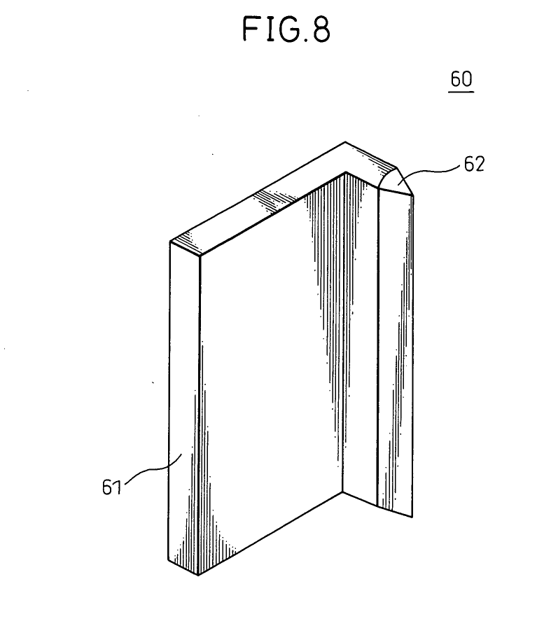

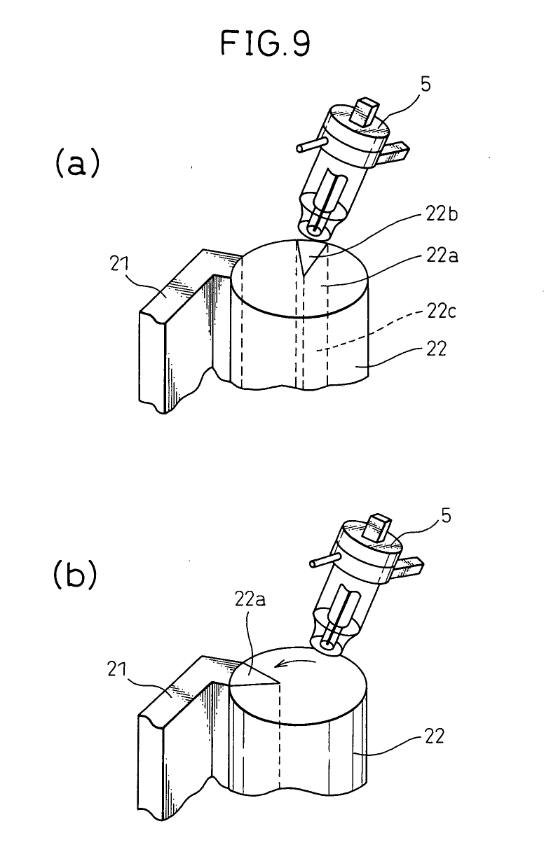

Next, a second embodiment of the present invention will be explained with reference to FIG. 8 and FIG. 9. The second embodiment is a mold apparatus 200 replacing the cavity partitioning member 3 of the first embodiment with a movable first space member 22. FIG. 8 is a view showing a two-color shaped article 60 molded in the second embodiment, for example, a door of a car air-conditioner. The two-color shaped article 60 is comprised of the main part 61 and the packing part 62. The main part 61 has an L-shape of a combination of two plates. At the end part of the L-shape, the packing part 62 is integrally molded. The packing part 62 is a columnar member with a fan-shaped cross-section. The main part 61 is made from a hard resin (second resin), for example, a general-use resin polypropylene, while the packing part 62 is made from a soft resin (first resin), for example, an elastomer.

The movement of the first space member will be explained with reference to FIG. 9. FIG. 9 gives views showing the internal structure of the mold. FIG. 9(a) is a view showing the relationship among the first space member 22, compact injection molding unit 5, and mold cavity (second space) 21 in the closed state. FIG. 9(b) is a view showing the relationship among the first space member 22, compact injection molding unit 5, and mold cavity (second space) 21 in the state communicated with the second space 21. The first space member 22, in FIG. 9, is shown with its bottom part omitted and only the top part shown. The cylindrically shaped first space member 22 has a columnar part 22a having part of its circular cross-section, that is, a fan-shaped part 22b, as a cross-section, cut away. Further, the cutaway fan-shaped columnar part forms the first space 22a.

The first space 22a is filled, in the state of FIG. 9(a), with the elastomer injected from the compact injection molding unit 5 (first resin injection step). Further, the injected and filled elastomer is cooled and solidified (first resin solidification step). When the elastomer solidifies, the first space member 22 rotates (displaces) in the arrow direction of FIG. 9(b). When stopping rotating, in the state of FIG. 9(b), the first space 22a filled with the elastomer is communicated with the second space 21 through its side surface 22c (first and second space communication step). Next, the second space 21 is filled by injection with molten polypropylene (second resin injection step). The elastomer filled in the first space 22a melt bonds with the molten polypropylene at the side surface 22c. Further, the polypropylene is cooled and solidified (second resin solidification step). In this way, the first resin (elastomer) and the second resin (polypropylene) are integrally molded whereby a two-color shaped article 60 is molded.

When the two-color shaped article 60 is molded, the mold starts to open. The elastomer positioned in the first space 22a becomes integral with the polypropylene positioned at the second space 21, sticks to the movable side mold, and detaches from the first space 22a positioned in the fixed side mold (shaped article takeout step). When the first space 22a becomes empty, the first space member 22 rotates in the opposite direction to the arrow direction of the FIG. 9(b) and returns to the original position shown in FIG. 9(a), whereby the first space 22a is cut off from the second space 21. In this way, a first space 22a closed for being filled with the elastomer by injection is formed (closed first space forming step). Next, the mold is closed (mold closing step). According to the second embodiment, it becomes possible to produce various shapes of first resin shaped parts.

The time charts explained in the first embodiment (FIG. 1) can also be used as they are in the second embodiment. For this reason, the explanation of the second embodiment using the time charts will be omitted.

### Third Embodiment

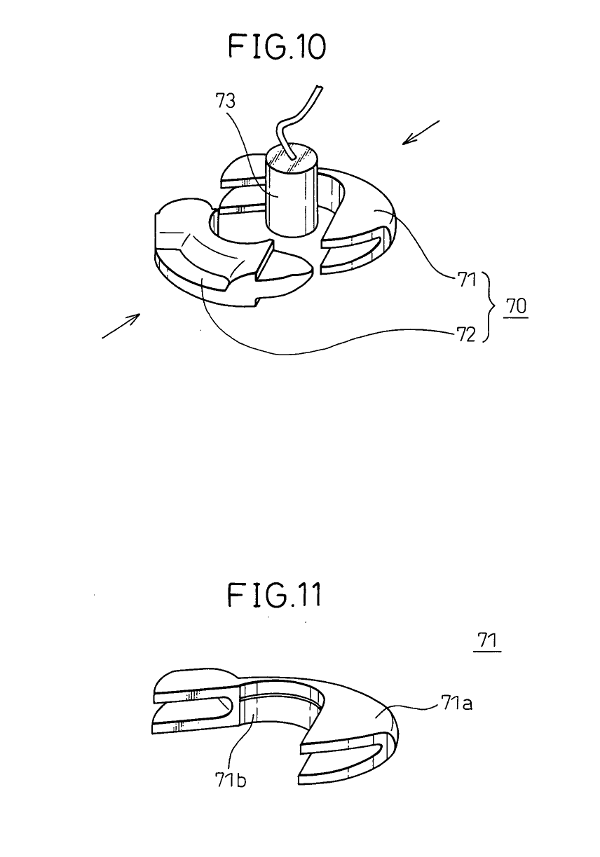

Next, a third embodiment of the present invention will be explained with reference to FIG. 10 to FIG. 13. The third embodiment is a mold apparatus 300 using a modification of the movable first space member 22 of the second embodiment. FIG. 10 is a view showing of a thermistor fixing coupling and thermistor (thermometer) 73 of a two-color shaped article 70, for example, car air-conditioner, molded in the third embodiment. The coupling 70 is comprised of a first coupling 71 and a second coupling 72. The coupling 70 grips the thermistor 73 by the two parts 71 and 72 to thereby seal the two by the packing parts.

FIG. 11 is a perspective view showing details of the first coupling 71. The first coupling 71 is comprised of a main part 71a and packing part 71b. The second coupling 72 is configured similar to the first coupling 71. Further, the main part 71a is made from a hard resin (second resin), for example, a general-use resin polypropylene, while the packing part 71b is made from a soft resin (first resin), for example, an elastomer.

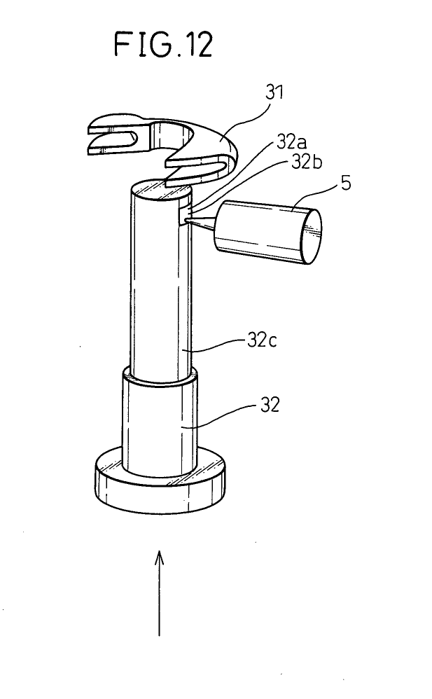

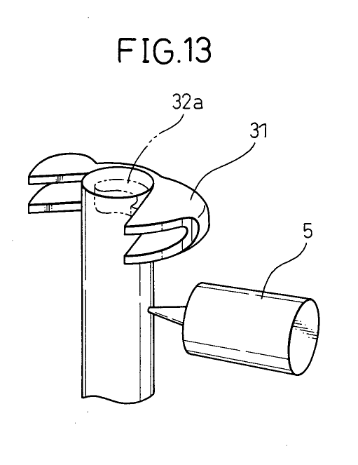

The movement of the first space member will be explained with reference to FIG. 12 and FIG. 13. FIG. 12 and FIG. 13 are views showing the internal structure of the mold. FIG. 12 is a view showing the relationship among the first space member 32, compact injection molding unit 5, and mold cavity (second space) 31 in the closed state. FIG. 13 is a view showing the relationship among the first space member 32, compact injection molding unit 5, and mold cavity (second space) 31 in the state where the first space 32a is communicated with the second space 31. The cylindrically shaped first space member 32 has part of the side surface of the cylinder cut away to form a semidonut shaped member. Further, the cutaway part of the semidonut shaped member forms the first space 32a.

The first space 32a is filled, in the state of FIG. 12, with an elastomer injected from the compact injection molding unit 5 (first resin injection step). Further, the injected and filled elastomer is cooled and solidified (first resin solidification step). Next, the first space member 22 rises (displaces) in the arrow direction of FIG. 12. After finishing rising, the state of FIG. 13 is reached. In this state, the first space 32a filled with the elastomer communicates with the second space 31 through the side surface 32b (first and second space communication step). Next, the second space 31 is filled with molten polypropylene by injection (second resin injection step). The elastomer filled in the first space 32a melt bonds with the molten polypropylene at the side surface 32b. Further, the polypropylene is cooled and solidified (second resin solidification step). In this way, the first resin (elastomer) and the second resin (polypropylene) are integrally molded to form a two-color shaped article 70.

When the two-color shaped article 70 is molded, the mold starts to open. The elastomer positioned in the first space 32a becomes integral with the polypropylene positioned at the second space 31, sticks to the movable side mold, and detaches from the first space 32a positioned in the fixed side mold (shaped article takeout step). When the first space 32a becomes empty, the first space member 32 displaces in the opposite direction to the arrow direction of FIG. 12 and returns to the original position shown in FIG. 12, whereby the first space 32a is cut off from the second space 31. In this way, a first space 32a closed for being filled with the elastomer by injection is formed (closed first space forming step). Next, the mold is closed (mold closing step). According to the third embodiment, it becomes possible to produce various shapes of first resin shaped parts.

The time charts explained in the first embodiment (FIG. 1) can also be used as they are in the third embodiment. For this reason, the explanation of the third embodiment using the time charts will be omitted.

By performing the elastomer molding step using the time Z from the time t2 to the time t7 in the range of the time period Y needed for the shaped article takeout step (A and B) and mold closing step C from the time t1 to the time t9, the time of the shaped article takeout step A and B and mold closing step C which was not actively used at all in the past can be used effectively for the molding process. By this, the molding time X of 1 cycle can be reduced.

In this way, it becomes possible to provide a two-color molding use mold apparatus able to be used even when the first cavity for molding the first thermoplastic resin and the second cavity for molding the second thermoplastic resin are completely different shapes or their connecting part is not a simple shape.

While the present invention has been described with reference to specific embodiments chosen for purpose of illustration, it should be apparent that numerous modifications could be made thereto by those skilled in the art without departing from the basic concept and scope of the present invention.

1. A mold apparatus for integral molding two types of thermoplastic resins to produce a two-color shaped article having a fixed side mold, a movable side mold freely openable and closable with respect to said fixed side mold, and a movable partitioning member which is arranged at least at one of said fixed side mold and said movable side mold and partitions a space for molding the two types of thermoplastic resins into a first space for molding a first thermoplastic resin and a second space for molding a second thermoplastic resin, characterized in that
said movable partitioning member is provided with a hole forming part of said second space.

2. A mold apparatus for integral molding two types of thermoplastic resins to produce a two-color shaped article having a fixed side mold, a movable side mold freely openable and closable with respect to said fixed side mold, and a movable partitioning member which is arranged at least at one of said fixed side mold and said movable side mold and partitions a space for molding the two types of thermoplastic resins into a first space for molding a first thermoplastic resin and a second space for molding a second thermoplastic resin, characterized in that
said movable partitioning member is provided with a first space.

3. A mold apparatus according to claim 1 or 2 characterized in that
said first thermoplastic resin is a soft resin and said second thermoplastic resin is a hard resin, and
said two-color shaped article is comprised of a main part and packing part, said main part is made by said second thermoplastic resin, and said packing part is made by said first thermoplastic resin.

4. A mold apparatus for integral molding a plurality of types of thermoplastic resins to produce a multi-color shaped article characterized by including a mold apparatus of claim 1 or 2.
